(19) United States
(12) Patent Application Publication
(10) Pub. No.: US 2008/0062698 A1
(43) Pub. Date: Mar. 13, 2008

(54) LED module

(76) Inventors: Yun Tai, Taipei City (TW); Ruey-Feng Tai, Changhua City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/519,956

(22) Filed: Sep. 13, 2006

(51) Int. Cl. F21V 29/00

(52) U.S. Cl. 362/294

(57) ABSTRACT

A LED module includes a heat sink, which is partially covered with an insulative layer and has a groove in a top recess thereof, and a plurality of mounting through holes cut through the top and bottom sides, a LED mounted in the groove of the heat sink, metal conduction plates fastened to the mounting through holes and extended to the outside of the heat sink, lead wires respectively connected between the metal conduction plates and positive and negative terminals of the LED, a light transmittance resin molded on the groove over the LED, and a lens holder fastened to the heat sink to hold an optical lens over the light transmittance resin.

### BACKGROUND OF THE INVENTION

1. Field of the Invention

The present invention relates to a LED (light emitting diode) and more particularly, to a LED module that dissipates heat quickly during operation.

2. Description of the Related Art

In recent decades, human beings consume energy heavily, resulting in an energy crisis. Nowadays, scientists in different countries are trying hard to develop new energy and every-saving products. In consequence, various petroleum substitutes have been developed, the utilization of solar power has been enhanced, and various low power consumption type fuel engines and motors and power-saving lighting fixtures have been created. Nowadays, LEDs (light emitting diodes) have been intensively used to substitute for conventional incandescent bulbs and fluorescent bulbs in various fields for the advantage of low power consumption.

The lower power consumption characteristic of LEDs is well known. Following fast development of semiconductor technology, high brightness LEDs are developed for use in many fields for illumination. For example, LEDs have been intensively used in motor vehicles for vehicle lights.

However, a LED must be packaged with a light transmittance resin before application. Because a high brightness LED releases much heat during operation and is enclosed in the package, heat cannot be quickly dissipated during the operation.

### SUMMARY OF THE INVENTION

The present invention has been accomplished under the circumstances in view. It is therefore the main object of the present invention to provide a LED (light emitting diode) module, which dissipates heat quickly during the operation of the LED (light emitting diode). According to one embodiment of the present invention, the LED module comprises a heat sink, which is partially covered with an insulative layer and has a groove in a top recess thereof, and a plurality of mounting through holes cut through the top and bottom sides, a LED mounted in the groove of the heat sink, metal conduction plates fastened to the mounting through holes and extended to the outside of the heat sink, lead wires respectively connected between the metal conduction plates and positive and negative terminals of the LED, a light transmittance resin molded on the groove over the LED, and a lens holder fastened to the heat sink to hold an optical lens over the light transmittance resin. According to another embodiment of the present invention, the LED module comprises a heat sink, the heat sink having a top side, a top groove in the top side, an insulative layer covered on the top side outside the groove; a metal thin film covered on the top groove; at least one light emitting diode respectively fixedly on the metal thin film; a plurality of metal conduction plates affixed to the heat sink; a plurality of lead wires respectively connected between the metal conduction plates and positive and negative terminals of the at last one light emitting diode; and a light transmittance resin molded on the groove of the heat sink and covering the light emitting diode.

### BRIEF DESCRIPTION OF THE DRAWINGS

FIG. 1 is an exploded view of a LED module in accordance with a first embodiment of the present invention.

FIG. 2 is a sectional assembly view of the LED module in accordance with the first embodiment of the present invention.

FIG. 2A is similar to FIG. 2 but showing the LED mounted on a metal thin film on the groove in the top recess of the heat sink.

FIG. 3 is a perspective assembly view of the LED module in accordance with the first embodiment of the present invention.

FIG. 4 is an exploded view of a LED module in accordance with a second embodiment of the present invention.

FIG. 5 is a sectional assembly view of the LED module in accordance with the second embodiment of the present invention.

FIG. 6 is a perspective assembly view of the LED module in accordance with the second embodiment of the present invention.

FIG. 7 is an exploded view of a LED module in accordance with a third embodiment of the present invention.

FIG. 8 is sectional assembly view of the LED module in accordance with the third embodiment of the present invention.

FIG. 9 is a perspective assembly view of the LED module in accordance with the third embodiment of the present invention.

### DETAILED DESCRIPTION OF THE PREFERRED EMBODIMENT

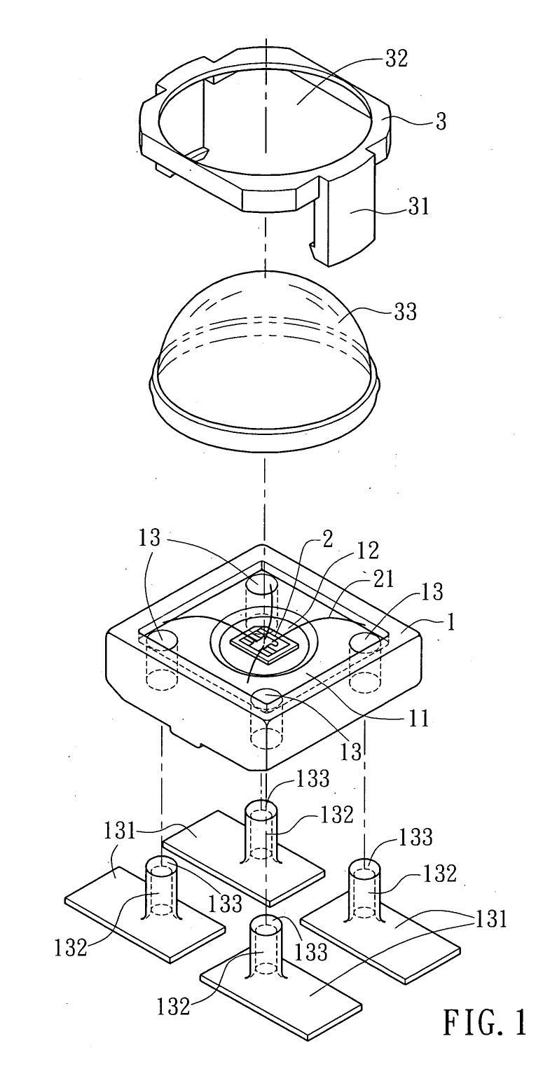

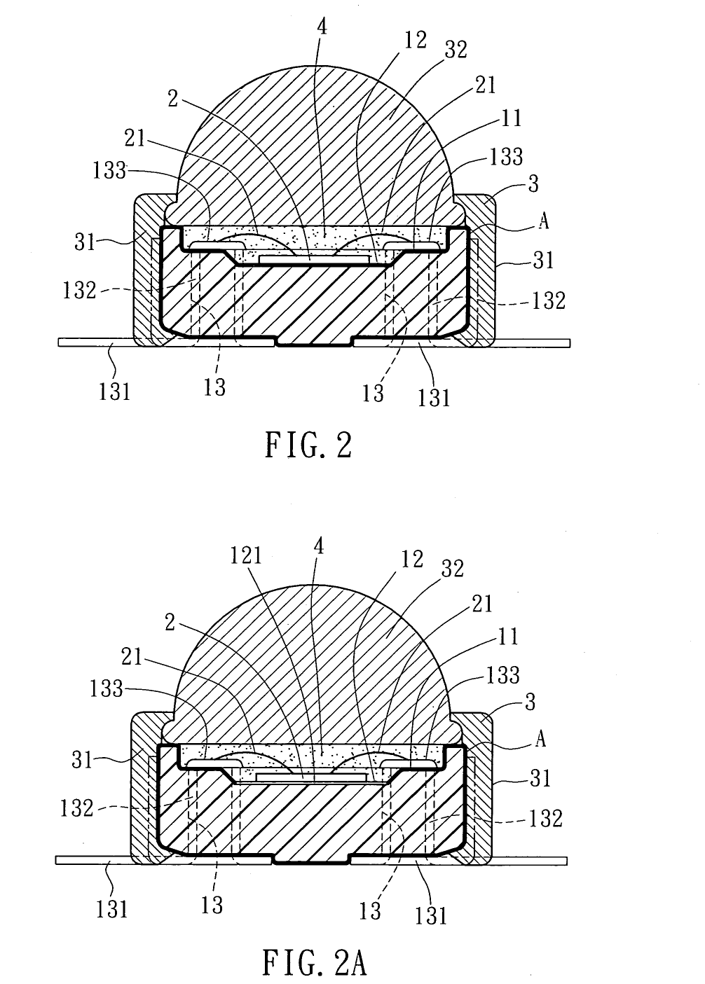

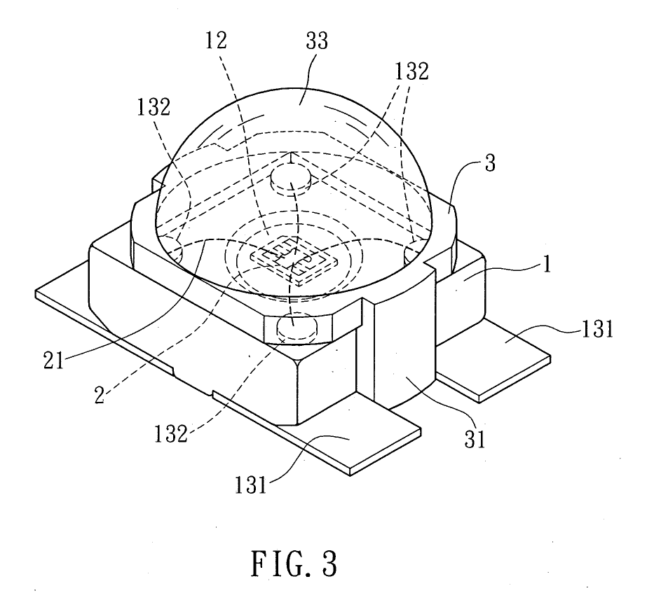

Referring to FIGS. 1-3, a LED module in accordance with a first embodiment of the present invention is shown comprising a heat sink 1, a LED (Light Emitting Diode) 2 mounted in the heat sink 1, and a lens holder 3 fastened to the heat sink 1 and holding an optical lens 33 corresponding to the LED 2. The heat sink 1 has a top recess 11, a groove 12 formed in the top recess 11 for the mounting of the LED 2, and a plurality of mounting through holes 13 cut through the top and bottom sides. Further, the top surface of the heat sink 1 is covered with an insulation layer A. Further, a plurality of metal conducting plates 131 are respectively fastened to the heat sink 1. The metal conducting plates 131 each have an upright shank 132 respectively inserted from the bottom side of the heat sink 1 into the mounting through holes 13. After insertion of the upright shanks 132 into the mounting through holes 13, the top ends 133 of the upright shanks 132 are hammered down to affix the upright shanks 132 to the heat sink 1. Further, lead wires 21 are respectively connected between the positive and negative electrodes of the LED 2 and the upright shanks 132 of the metal conducting plates 131. A light transmittance resin 4 is molded on the top recess 11 over the LED 2, keeping the LED 2 embedded in the light transmittance resin 4. The lend holder 3 has a plurality of bottom hooks 31 respectively hooked on the bottom edge of the heat sink 1, and a center opening 32. The optical lens 33 is fastened to the center opening 32 of the lens holder 3. The heat sink 1 is made out of a metal material, for example, gold, silver, copper, iron, aluminum, or their alloy that transfers heat energy efficiently. Further, a metal thin film 121 may be directly bonded to the groove 12 that is not covered by the insulative layer A so that the LED 2 can be directly fastened to the metal thin film 121. During the operation, heat energy is quickly transferred from the LED 2 to the heat sink 1 through the metal thin film 121 (see FIG. 2A). The metal thin film 121 can be a film of nickel gold alloy, nickel silver alloy, or nickel copper alloy.

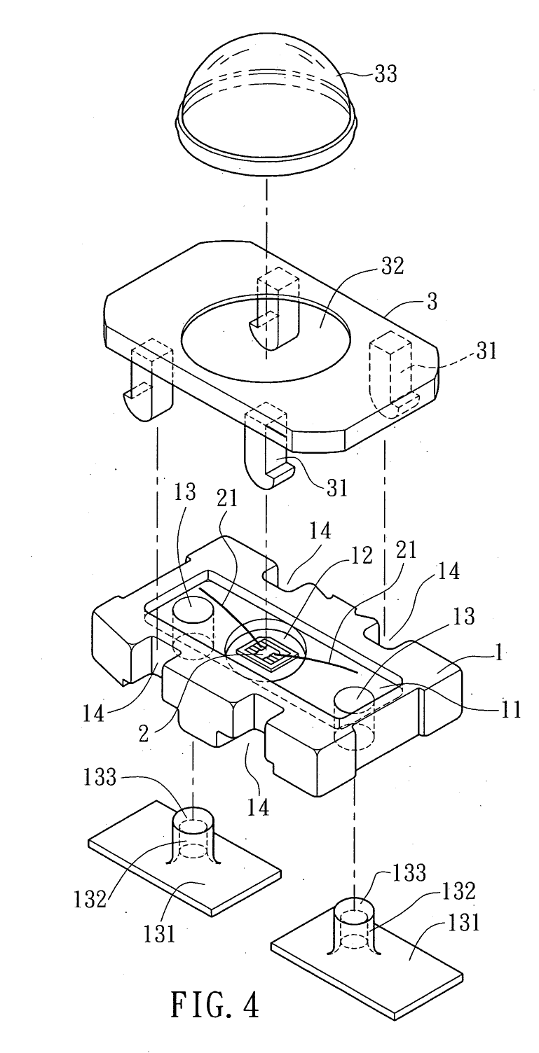

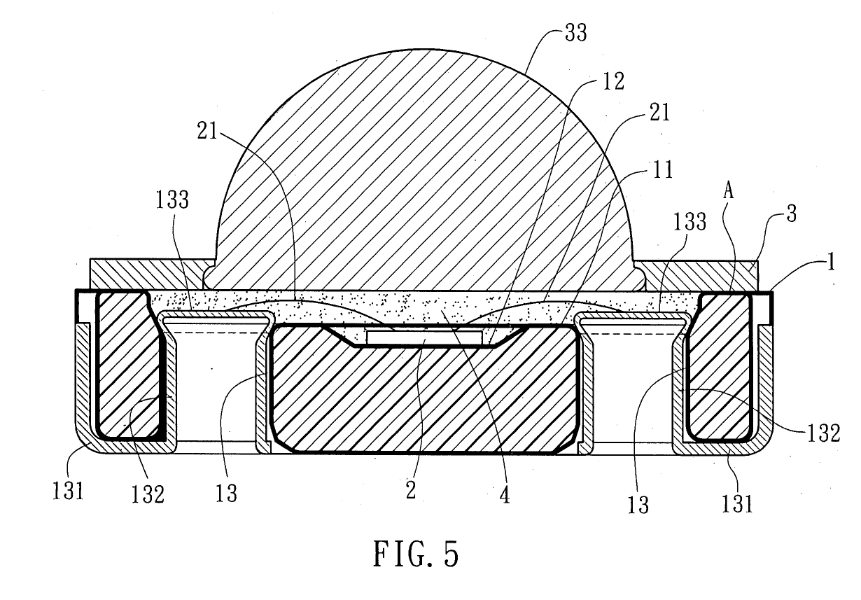

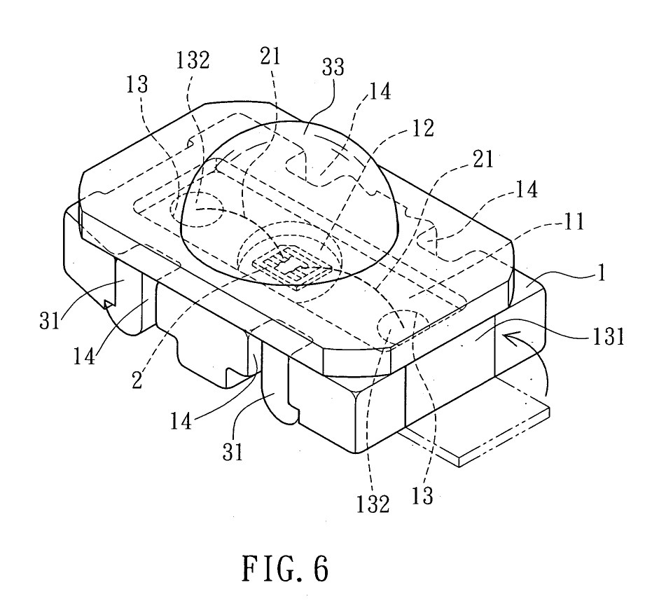

FIGS. 4-6 show a LED module in accordance with a second embodiment of the present invention. This embodiment is substantially similar to the aforesaid first embodiment with the exception that the heat sink 1 has a plurality of peripheral notches 14 for securing the bottom hooks 31 of the lens holder 3. Further, the heat sink 1 has only two mounting through holes 13 for the mounting of two metal conducting plates 131.

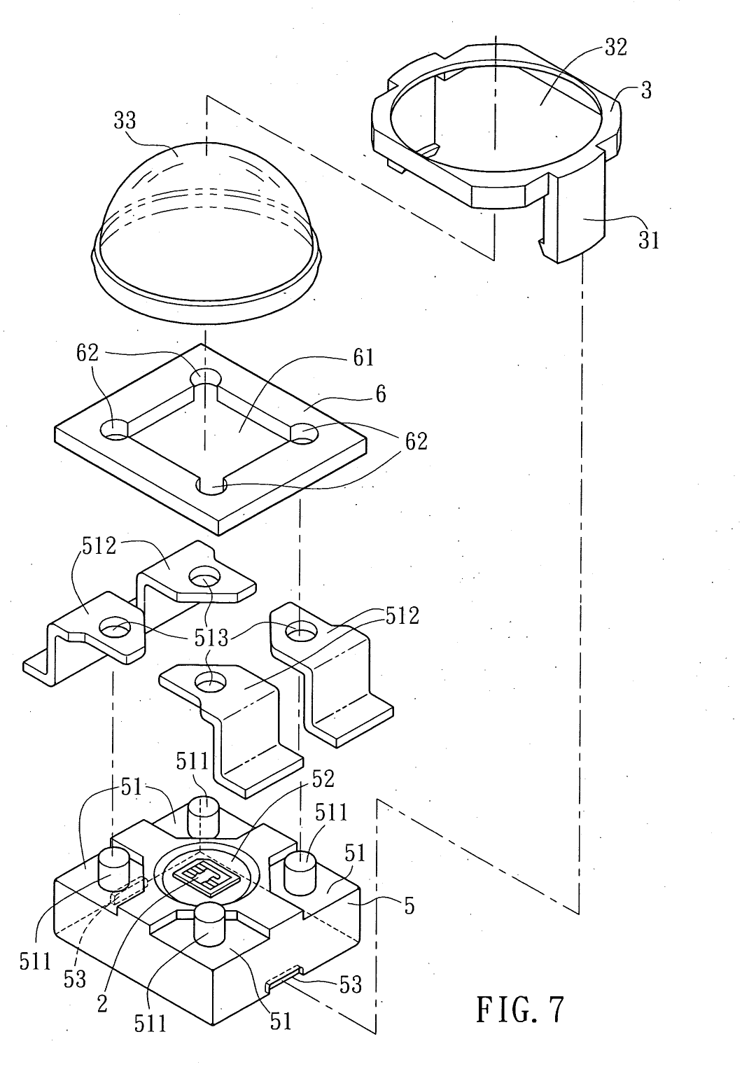

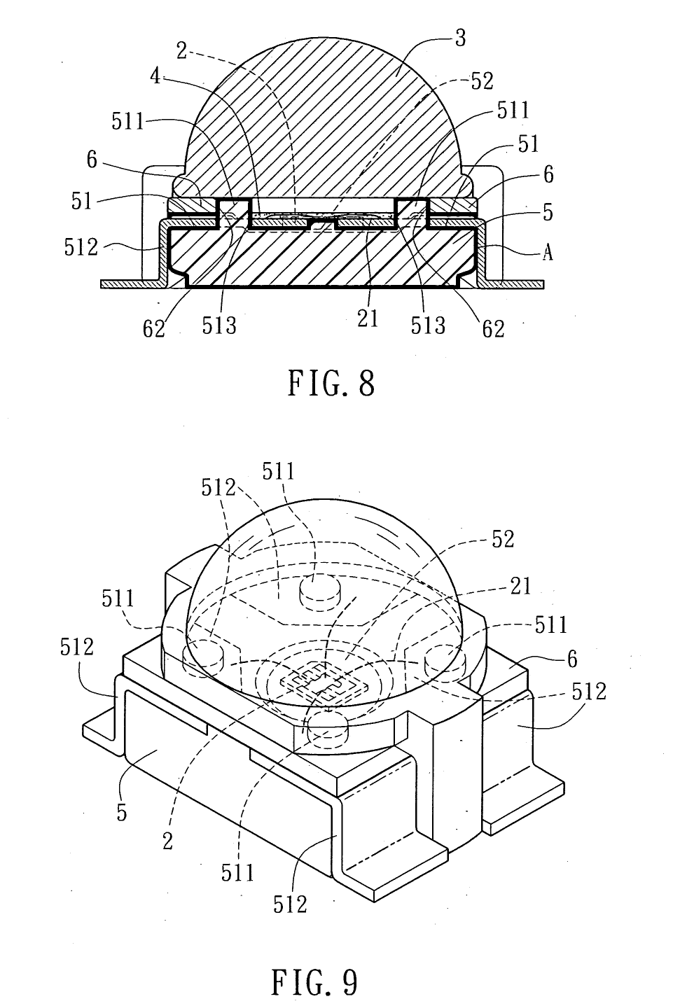

FIGS. 7-9 show a LED module in accordance with a third embodiment of the present invention. According to this embodiment, the LED module comprises a heat sink 5, a LED (Light Emitting Diode) 2 mounted in the heat sink 5, and a lens holder 3 fastened to the heat sink 5 and holding an optical lens 33 corresponding to the LED 2. The heat sink 5 has a top center recess 52 for the mounting of the LED 2, a plurality of top border recesses 51 spaced around the top center recess 52, an upright rod 511 respectively disposed in each top border recess 51, and a plurality of peripheral bottom notches 53. Further, the top surface of the heat sink 5 is covered with an insulation layer A. Further, a plurality of metal conducting plates 512 are respectively fastened to the top border recesses 51 of the heat sink 5 and extended to the periphery of the heat sink 5. The metal conducting plates 512 each have a vertical through hole 513 respectively coupled to the upright rod 511. Further, lead wires 21 are respectively connected between the positive and negative electrodes of the LED 2 and the metal conducting plates 512. A light transmittance resin 4 is molded on the top side of the heat sink 5 over the LED 2, keeping the LED 2 embedded in the light transmittance resin 4. The lend holder 3 has a plurality of bottom hooks 31 respectively hooked on the peripheral bottom notches 53 of the heat sink 5, and a center opening 32. The optical lens 33 is fastened to the center opening 32 of the lens holder 3. Further, a locating frame 6 is sandwiched between the heat sink 5 and the lens holder 3, having a center opening 61 corresponding to the center opening 32 of the lens holder 3, and a plurality of inside notches 62 that accommodate the upright rods 511 respectively.

In the aforesaid embodiments, the lens holder 3 and the optical lens 33 are two independent members. Alternatively, the optical lens 33 can be formed integral with the lens holder 3. If desired, the lens holder 3 and the optical lens 33 can be eliminated from the LED module. Further, the LED module can be made carrying two or more LEDs 2.

Although particular embodiments of the invention have been described in detail for purposes of illustration, various modifications and enhancements may be made without departing from the spirit and scope of the invention.

1. A LED module comprising:
a heat sink having an insulator layer formed over a portion thereof, said heat sink having a top recess in a top side thereof, a groove in said top recess devoid of said insulation layer and a plurality of mounting through holes cut through top and bottom sides thereof and spaced round said groove;
at least one light emitting diode respectively fixedly mounted in said groove of said heat sink;
a plurality of metal conduction plates affixed to said heat sink at a bottom side, said metal conducting plates each having an upright shank respectively affixed to the mounting through holes of said heat sink;
a thin metal film sandwiched between said light emitting diode and said groove of said heat sink, said thin metal film extending and mounted to a top end of each of said upright shanks, a bottom end of said upright shanks contacting said metal conducting plates;
a plurality of lead wires respectively connected between said metal conduction plates and positive and negative terminals of said at last one light emitting diode; and
a light transmittance resin molded on said, groove of said heat sink and covering said light emitting diode,
whereby a heat transfer path is formed from said light emitting diode through said thin metal film, said upright shanks and said conducting metal plates in a continuous matter for dissipation of heat.

2. The LED module as claimed in claim 1, further comprising a lens holder fastened to said heat sink to hold an optical lens over said light transmittance resin, said lens holder having a plurality of bottom hooks respectively hooked on a bottom edge of said heat sink.

3. The LED module as claimed in claim 2, wherein said lens holder has a center opening for accommodating said optical lens.

4. (canceled)

5. The LED module as claimed in claim 4, wherein said heat sink is made of a metal material of high substantial amount of coefficient of heat transfer.

6. The LED module as claimed in claim 1, further comprising a lens holder fastened to said heat sink, said lens holder having a plurality of bottom hooks respectively hooked on a bottom edge of said heat sink, and an optical lens formed integral with said lens holder and covered over said light transmittance resin.

7. A LED module comprising:
a heat sink having an insulation layer formed over a portion thereof, said heat sink having a top side, a top groove in said top side devoid of said insulation layer;
a thin metal film covered on said top groove;
at least one light emitting diode respectively fixedly on said metal thin film;
a plurality of metal conduction plates affixed to said heat sink;
said thin metal film sandwiched between said light emitting diode and said groove of said heat sink, said thin metal film extending and mounted to a top end of each of said upright shanks, a bottom end of said upright shanks contacting said metal conducting plates;
a plurality of lead wires respectively connected between said metal conduction plates and positive and negative terminals of said at last one light emitting diode; and
a light transmittance resin molded on said groove of said heat sink and covering said light emitting diode,
whereby a heat transfer path is formed from said light emitting diode trough said thin metal film, said upright shanks and said conducting metal plates in a continuous manner for dissipation of heat.

8. A LED module comprising:
a heat sink, said heat sink having a top side covered with an insulative layer, a top center recess formed on said top side, a plurality of top border recesses formed on said top side and spaced around said top center recess, and a plurality of upright rods respectively upwardly extending from said top side in said top border recesses;
at least one light emitting diode respectively fixedly mounted in said top center recess;
a plurality of metal conduction plates respectively fastened to the top border recesses of said heat sink, said metal conducting plates each having a vertical through hole respectively fastened to said upright rods of said heat sink;
said metal plate is inserted into said upright rod, said metal plate having an L-shaped feature at both ends of said metal plate, a top end of said metal plate with said L-shaped feature is directed to said heat sink, a bottom end of the metal plate with said L-shaped feature is directed away from said heat sink:
said metal plate and said upright rod are made of material of substantial amount of coefficient heat transfer:
a plurality of lead wires respectively connected between said metal conduction plates and positive and negative terminals of said at last one light emitting diode; and
a light transmittance resin molded on said groove of said heat sink and covering said light emitting diode.

9. The LED module as claimed in claim 8, further comprising a lens holder fastened to said heat sink and holding an optical lens over said light transmittance resin.

10. The LED module as claimed in claim 9, further comprising a locating frame sandwiched in between said lens holder and said heat sink, said locating frame having a center opening corresponding said light transmittance resin and a plurality of inside notches that accommodate said upright rods of said heat sink respectively.

11. The LED module as claimed in claim 8, wherein said heat sink is made of a metal material of high substantial amount coefficient of heat transfer.

12. The LED module as claimed in claim 8, further comprising a lens holder fastened to said heat sink, said lens holder having a plurality of bottom hooks respectively hooked on a bottom edge of said heat sink, and an optical lens formed integral with said lens holder and covered over said light transmittance resin.
